(19) United States
(12) Patent Application Publication
(10) Pub. No.: US 2002/0072276 A1
(43) Pub. Date: Jun. 13, 2002

(54) Multilayer connector for electronic signals

(76) Inventor: Daniel Raymond Lewis, Incline, NV (US)

Correspondence Address: Charles Hartman, P.O. Box 926, Reno, NV, 89505, US

(21) Appl. No.: 10/056,844

(22) Filed: Nov. 9, 2001

Related U.S. Application Data
(63) Continuation-in-part of application No. 09/379,708, filed on Aug. 24, 1999.

(51) Int. Cl. H01R 13/502

(52) U.S. Cl. 439/701

(57) ABSTRACT

A plurality of telecommunications lines is received by a connector on a motherboard. Each connector supports a plurality of removable and replaceable modules, and each module can receive at least two telephone or other electronic data communications lines. Each module has a first layer and a second layer of electronic signal receiving ports, and a first and second circuit board to precondition a signal before it is sent to or from the motherboard. The motherboard communicates with external devices by signals received and sent through the telecommunications lines received by the electronic signal receiving ports. Each of the individual modules can be easily removed and replaced without requiring the removal of the connector from the motherboard.

### RELATED APPLICATIONS

This application is a continuation-in-part of U.S. patent application Ser. No. 09/379,708 filed on Aug. 24, 1999.

### BACKGROUND OF THE INVENTION

1. Field of the Invention

This invention relates to remote jack connectors that can receive more than one external connector; in particular, this invention relates to multiple remote jack connectors designed to be mounted on printed motherboards in removable modules.

2. State of the Art

The electrical connectors commonly known as modular telecommunications receptacles or jacks, have been known for many years. Although connectors of this general type were originally designed for use in telephone systems, they have found their way into wide acceptance in a variety of other contexts. For example, modular jacks are now commercially used as input/output interface connectors for networking computers together, and have found particular use in local networks where all the computers in the network are physically near each other.

These connectors can be used to join two, or more, computers, or terminals, and their associated peripheral devices, into large local networked arrays. Most of the computers and peripherals in the network will be connected to a server, a computer which functions as a switchboard for the network. One problem conventional jacks present in the larger networks is the limited number of connections they allow one to make on the server end of the network. In particular, in a large local network one needs to connect many terminals to the server, which may not be large enough to house enough conventional jacks for the large number of connections one would like to make. Preferably, for convenience and simplicity, all the local devices should be connected to a single server. Varieties of solutions to this problem have been advanced, including stacking jacks on top of each other to double the number of jacks available for connection.

A companion problem has been created by the need for placing many connections in a small physical area. It is generally appreciated that the signals of the lines coming to and from the jacks should be as crisp as possible. Conventionally, to help condition signals received from the outside world, as well as those signals emanating from the server, it is frequently desirable to condition the signals using magnetic means. The problem arises because, conventionally, all such conditioning is done on the motherboard. However, as the number of jacks increases on the motherboard, the difficulty of mounting enough conditioning for the jacks on the motherboard and separating the magnetic conditioning means for the different jacks becomes significant. Moreover, the motherboard mounted magnetic conditioning for a first jack may interfere with the motherboard mounted conditioning for a second jack disposed proximately to the first jack. Although one convenient solution for the increasing the number of jacks is to use stacked arrays of jacks, the conditioning required for these arrays is frequently neglected as there is no room for all the conditioning apparatus needed on the motherboard.

A final related problem is that if one of the jacks in a conventional stacked array is defective, the user of the conventional array must either remove the entire array from the motherboard or choose not use one or more of the defective ports. Neither option is acceptable in high volume, densely packed networks. Clearly, the industry would benefit greatly from a multiport connector which included magnetically conditioning for the signals from each jack. This multiport connector should prevent interference of the conditioning of a signal received by one jack from the conditioning of signals received by nearby companion jacks. Moreover, this multiport connector should allow the user to remove and replace defective ports as needed without removing the entire multiport connector from its motherboard and replacing it.

### SUMMARY OF THE INVENTION

This invention provides a means to allow a plurality of telecommunications lines to be received by a connector on a motherboard. Each connector supports a plurality of removable and replaceable modules, and each module may receive at least two telephone or other electronic data communications lines. Each module has a first layer and a second layer of electronic signal receiving ports, and a first and second circuit board to precondition a signal before it is sent to or from the motherboard. The motherboard communicates with external devices by signals received and sent through the telecommunications lines received by the electronic signal receiving ports. Each of the individual modules can be easily removed and replaced without requiring the removal of the connector from the motherboard.

A first aspect of this invention is a connector, comprising:

a housing having module receiving bays;

at least one module removably mounted in at least one module receiving bay, the module having;

a first end of a first external lead receiver located in at least one first jackconnector lead forming a connection for an external electronic source of electronic signal disposed at a first level in the module, located in a jack portion of the module;

a first end of a second external lead receiver located in at least one second jack connector lead for connecting with an external source of electronic signal disposed at a second level in the module above the first level, the at least one first jack connector leads being disposed in a second level in the module, disposed in the jack portion of the module;

a second end of the first external lead receiver leading to and connected with at least one first circuit board having circuitry, the circuit board disposed in a circuit board portion of the module,

a second end of the second external lead receiver leading to and connected with at least one second circuit board having circuitry, the first circuit board and the second circuit board being disposed in a circuit board portion of the module; and

electrical shielding disposed at at least partially between the jack portion of the module and the circuit board portion of the module;

a first plurality of spring contacts in the housing removably connecting with a first plurality of connecting conductive leads extending from the first plurality of circuit boards and a second plurality of spring contacts, said second spring contacts in the housing removably connecting with said second plurality of spring contacts in the housing extending connecting with a second plurality of circuit boards; and

motherboard connective pins extending downwardly from the spring contacts.

A second aspect of this invention is a connector, comprising:

a housing having module receiving bays;

at least one module mounted in at least one module receiving bay, the module having;

a first end of a first external lead receiver located in at least one first jack connector lead forming a connection for an external electronic source of electronic signal disposed at a first level in the module, located in a jack portion of the module;

a first end of a second external lead receiver located in at least one second jack connector lead for connecting with an external source of electronic signal disposed at a second level in the module above the first level, the at least one first jack connector leads being disposed in

a second level in the module, disposed in the jack portion of the module;

a second end of the first external lead receiver leading to and connected with at least one first circuit board having circuitry, the circuit board disposed in a circuit board portion of the module, a second end of the second external lead receiver leading to and connected with at least one second circuit board having circuitry, the first circuit board and the second circuit board being disposed in a circuit board portion of the module; and

electrical shielding disposed at least partially between the jack portion of the module and the circuit board portion of the module;

a first plurality of spring contacts in the housing connecting with a first plurality of connecting conductive leads extending from the first plurality of circuit boards and a second plurality of spring contacts, said second plurality of spring contacts in the housing extending connecting with a second plurality of circuit boards; and

motherboard connective pins extending downwardly from the spring contacts.

A third aspect of this invention is a connector module, comprising:

a first level external lead receivers and a second level of external lead receivers within a module housing, the first level of external lead receivers disposed below the second level of external lead receivers;

the first level of external lead receivers and the module housing forming a jack opening to a first circuit board for processing an electric signal;

the second level of external lead receivers and the module housing forming a second jack opening to a second circuit board for processing an electric signal; and

an electrical shield member interposed between the first level external lead receivers and second level external lead receivers.

### BRIEF DESCRIPTION OF THE DRAWINGS

FIG. 1 shows a perspective view, presenting the front and top surfaces, of the connector of this invention.

FIG. 2 shows a perspective view, presenting the back and top surfaces, of the connector of shown in FIG. 1.

FIG. 3 shows a perspective exploded view, presenting the back and top surfaces, of the connector shown in FIG. 2

FIG. 4 shows a perspective exploded view, presenting the front and top surfaces, of the connectors shown in FIG. 2 and FIG. 3.

FIG. 5 shows a perspective exploded view, presenting the bottom surface and the rear surface, of the connector module identified by numeral 30 in FIG. 2.

FIG. 6 shows a perspective view of the housing of the invention.

FIG. 7 shows a cutaway side view of the connector of this invention, showing the electrical connections from the external jack to the motherboard mounting pins.

FIG. 8 shows an electronic schematic diagram showing one possible method of magnetically treating a signal both coming into the connector from the outside, and coming into the connector from a motherboard and going to the outside.

### DETAILED DESCRIPTION OF THE PREFERRED EMBODIMENT

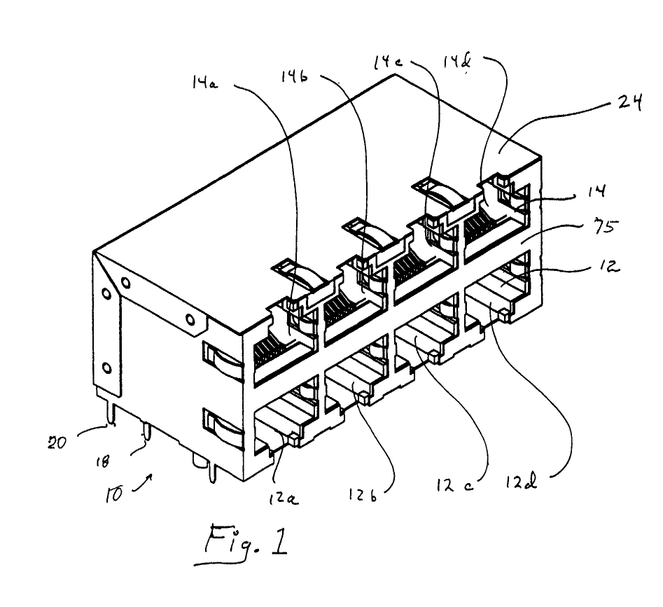

Referring to FIG. 1, an RJ connector 10, has a plurality of jack receiving stations disposed in a 4×2 rectangular matrix. The lower level of the jack receiving openings 12 are disposed directly below the top layer of jack receiving openings 14. The four bottom openings 12a, 12b, 12c, and 12d, and the top openings 14a, 14b, 14c, and 14d therefore form the rectangular matrix of openings. Boundary member 75 separates the lower level of jack openings from the top level of jack openings. The electrical connections extend from the housing; a first electrically conductive lead 18 is disposed in front of a second, discrete, electrically conductive lead 20. The two groups of connections, which together comprise the motherboard connective pins, are received by pre-drilled holes in a motherboard (not shown in the FIGS. ) 20 to receive and mount the connector 10. The motherboard can be any conventional motherboard, whether a commercially available or custom fabricated, that communicates with external devices or is to be connected with a local area network through standard jacks.

A first plurality of jack openings 12 are disposed at a first level in the housing 24. Similarly, a second row of jack openings 14 are disposed at a second level in the housing above the first level. Although it is greatly preferred that the first level of jack openings are disposed directly above the second level of jack openings, it is possible to have staggered openings. The leads that extend downwardly from the housing, the motherboard connective pins 19, provide the means for attaching the connector to a motherboard.

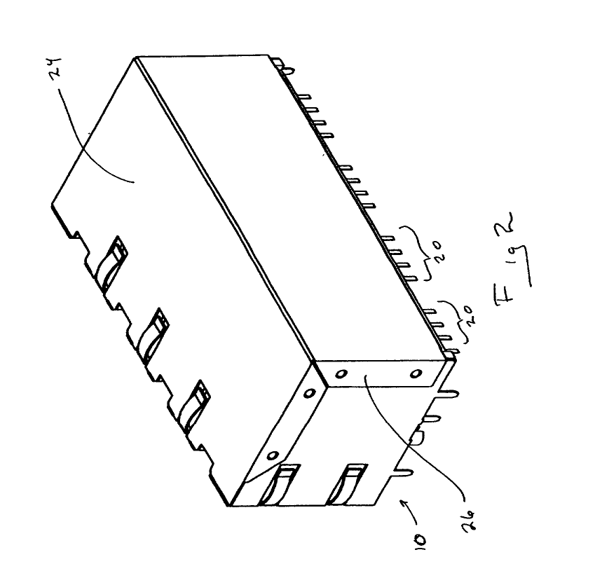

Referring to FIG. 2, a second plurality of jack connections 20 extends downwardly from the bottom of the housing 24. The external portion of the connector 10 is a housing shield 26, preferably a metallic, non-electrical shielding member.

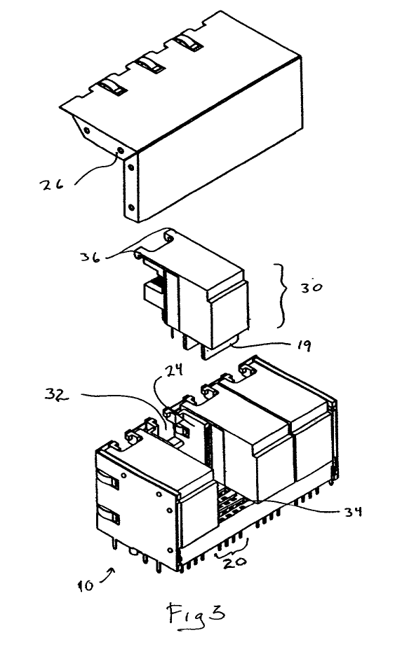

Referring to FIG. 3, the same embodiment of the connector 10 shown and described above is shown partially disassembled. A module 30 is removed for subsequent replacement from the receiving housing opening 32. Each of the various modules mounted in the housing can easily be removed and replaced as shown in FIG. 3. A plurality of pins 19 extend downwardly from the connector and connect with the external pins 20. The pins are connected to the circuit board electric receiver body 34. The module 30 is removable from the housing while the connector is attached to the motherboard. Each module contains the components for the two-level connector. Arms 36 allow the module to be received and secured into the module receiver body of the connector to form the external jack receiving openings 12 and 14.

The modular design is greatly preferred because, as shown, it allows single pairs of stacked jacks to be removed for maintenance or repair. It should be noted that the module 30 cannot, standing alone, receive an external telephone jack. However, the jack openings are formed when the module is placed in the housing. Then the first level of connectors, together with the housing, form a first telephone jack opening leading to a first circuit board for processing an electric signal; similarly, the second level of connectors, together with the housing, forms a second telephone jack opening leading to a second circuit board for processing an electric signal. The plurality of stacked jack modules that make up the complete connector 10 is received into the module housing 24 and are secured therein with the housing shield 26.

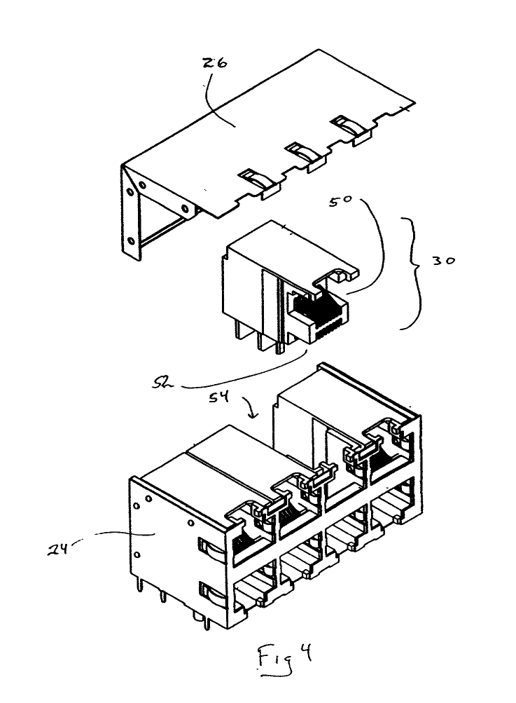

Referring to FIG. 4, the housing shield 26 is open on the jack receiving side of the connector. When in place it covers only the top and the back of the connector housing. The housing shield 26 is removably connected for easy removal to allow access to the modules connected to the connector inside. The module 30 has a top portion 50 and a bottom portion 52. Each portion can receive an external jack. A top portion of the housing shield 26 is adapted to sit on the top surface of the module housing 24 when the housing is shielded, and module 30 is connected in receiving hole 54 the module. In the embodiment shown, only after the module has been received by the frame will the jack opening be formed to receive external jacks.

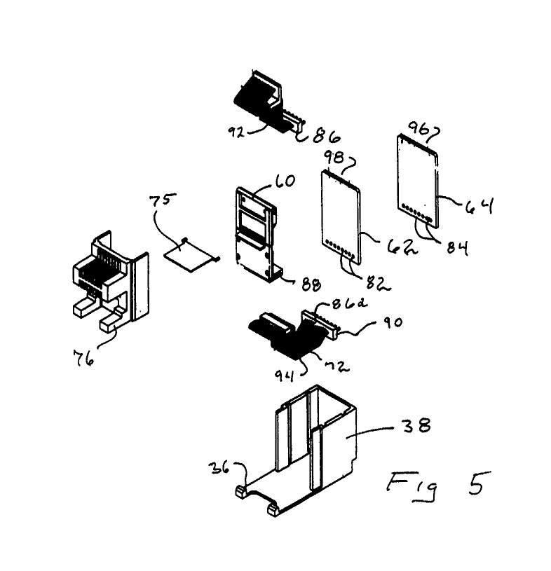

Referring to FIG. 5, one of the plurality of modules 30 (FIG. 3) has been exploded to show means for electrically and magnetically conditioning the signal. Here that means are the circuit boards 62 and 64, which are interposed between the jack openings 12 and 14 and the motherboard the connector is mounted on (not shown here). Therefore, all signals whether generated by the motherboard or generated externally will pass through one of the circuit boards and be preconditioned. The circuit board portion of the connector receives the signals generated externally that are received by the first plurality of jack receiving openings 12 and the second plurality of jack receiving openings 14 (both 12 and 14 shown on FIG. 1); similarly, the signals generated by the motherboard pass through the motherobard. A jack boundary member 75 separates the first external lead receivers 92 from the second external lead receivers 94.

Each of the first plurality of jack openings 12 (FIG. 1) has a series of wire connections, the first external lead receivers 92, extending from the first opening to a first circuit board 62 located behind the jack opening. Similarly, a second plurality of lead receivers 94 extends from the second opening 12 (FIG. 1) to a second circuit board 64. The first circuit board 62 and the second circuit board 64 are located behind an electric shield 60. The lead guides 88 and the hardware to allow circuit board positioning within the assembly are positioned between the first plurality of leads and the second plurality of leads. This reduces or prevents cross talk between the leads and interference between the magnetic components on the board and the line signals to and from the jack connector.

The first external lead receivers 92, attached to circuit board receiving holes 84, and the second series of wire connections 94, attached to circuit board receiving holes 82, are attached on opposite sides of the lead guide 88. The leads extend past the shield member and, in this Fig. , extend downwardly. The ends of the leads are secured by a first lead securing member 86 and a second lead securing member 86a. The secured leads can then accurately enter the lead receiving apertures 82 defined in the first circuit board 62. Similarly, the second series of lead receivers 92 are attached to the lead guide 88 and follow the first side of the shield member 60 to the bottom where they dip below the first series of lead receivers and pass to a second lead securing member 86a. The secured leads can then accurately enter the lead receiving apertures 84 defined in the second circuit board 64.

All of the circuitry that conditioned the signal fit into the module 30, which is shown upside down relative to its orientation in FIG. 2. The assembled housing member is attached to the motherboard. The arms 36 are lower most in this view. The circuitry fits behind the electrical shield member 60, and the front jack member 76 fits on the front to provide the physical connection for the external jack.

At the bottoms of circuit boards 62 and 64 are body receivable electronic leads 96 and 98 that extend downwardly to be connected to the module receiver body 24.

Once the interior structure of the apparatus of the present invention is understood, one can view the apparatus as shown in FIGS. 1 and FIG. 3, as a connector module, having a first level of a first plurality of jack openingsl2 and a second level of a second plurality of jack openings 14, the first level disposed below the second level. When viewed together with the housing, the first level is adapted to form a telephone jack opening connected to a first circuit board 62 for processing an electric signal; similarly, the second level of connectors is adapted to form a second telephone jack opening to a second circuit board 64 for processing an electric signal. As shown in FIG. 5, a shield member 60 is interposed between, on the one hand the first level and second level, which together form the jack portion of the module, and, on the other, the first and second circuit boards, which form the circuit board portion of the module.

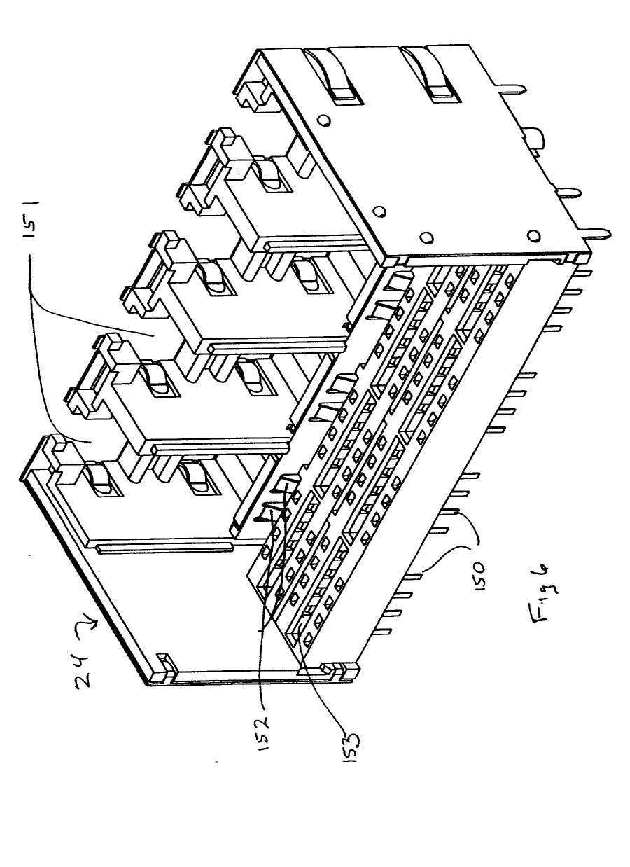

Referring to FIG. 6, the housing 24, has a plurality of bays 151 to removably receive modules 30 (not shown). The modules have electronic leads 96 extending downwardly (not shown here) that removably connect with the spring loaded electronic connectors 150 disposed in the bottom of the body. The electronic leads extending from the module press the electronic connectors 153 in the body apart and form a signal conducting path when the leads of the modules are removably connected thereto. The electric shield 60 (FIG. 5) is grounded by contacting the electronic grounding leads 152. The external leads of the body are connected to the motherboard, and once connected, the modules can individually be connected or removed from the body.

It will, of course, be appreciated that the body can be made of any non-conductive material, for example, plastic. The leads referred to herein are made from any conventional conductive material, especially preferred materials being copper and gold. The shield is made from any nonconductive material, preferably metal, such as sheet brass and the like.

Once the various pieces of the apparatus are manufactured, the metal parts by stamping and similar methods, and the plastic parts by molding and similar techniques, assembling the connector for distribution in commercial channels is largely a matter of putting them together as shown in the Figs. The unit will typically be shipped as a whole piece. However, as mentioned above, if one of the modules fails to perform, it can be shipped to the user who replaces the module without removing the entire connector from the motherboard. This is greatly preferable since the connector is preferably soldered to the motherboard.

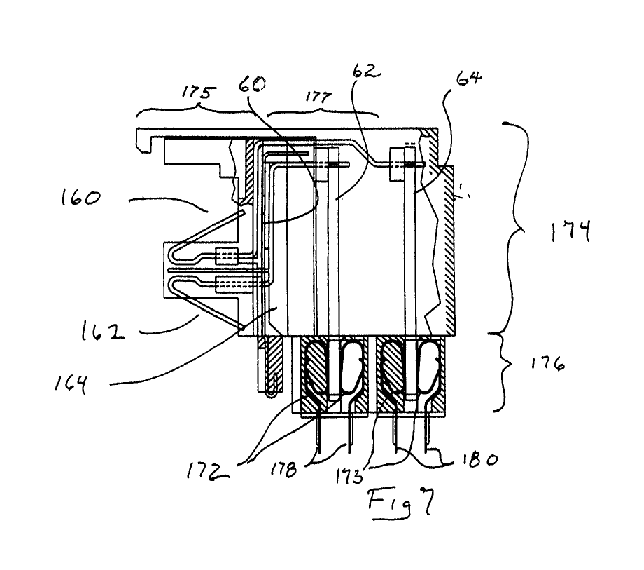

Referring to FIG. 7, in an unassembled jack, a first connector lead 160 is disposed over a second connector lead 162. An electrical shield 60 interposed between the first connector lead and the second connector 25 lead prevents cross talk between the first connector lead and the second connector lead. The second connector lead is bent upwardly and passes to the top of the electrical shield member 60. The first connector leads is similarly bent upwardly. The first connector lead passes upwardly on a first side of the electrical shield and is separated from the second connector lead 5 which passes upwardly on the second side of the electrical shield.

The two electrically conductive leads pass upwardly along the lead guides 88, but on different sides of the shield, and pass to their respective circuit boards over the top most level of the shield. The second plurality of electrically conductive leads 165 are then presented to the first circuit board 62. The first plurality of electrically conductive leads 167, those that lead to the second circuit board 64, pass over the top of the first circuit board. Whatever signal the leads are passing from an external source to the motherboard, or from the motherboard to the external source, goes past one of the circuit boards first. Both circuit boards are received by spring contacts or clip connectors 172 and 173 that firmly, yet removably, hold the circuit boards in place. The module is divided into a jack receiving portion 175 and a circuit board portion 177. Both the motherboard connective pins 19 and the connector leads 178 and 180 form a path from the clip connectors to the external portion of the connector for being received by apertures preformed in a motherboard. The top portion 174 of the connector, the module portion containing the electrical shielding and the circuit boards is removable from the bottom portion 176.

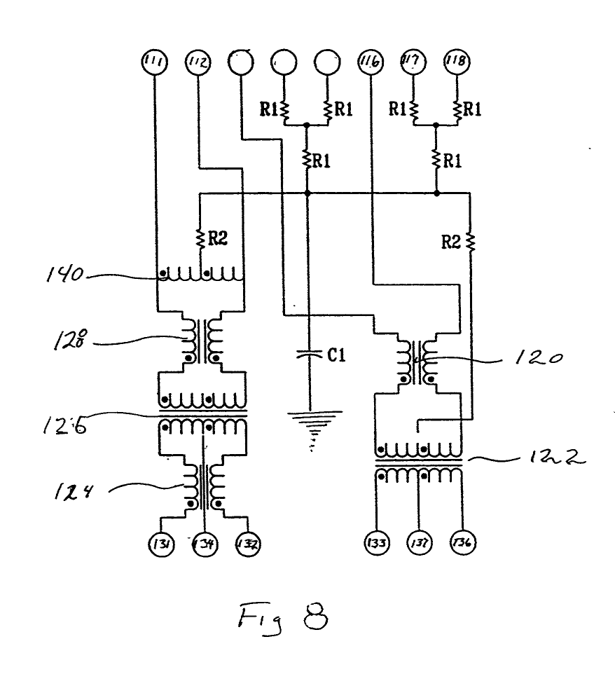

Referring to FIG. 8, one of many possible alternative circuits for circuit boards 62 and 64 is shown. Here, the signal has a first path of being received from an external signal from the jack opening. Such an external signal can be, for example, from a telephone line, such as an Internet signal, or from a server or other locally networked device. This external signal is then routed to the first circuit board or the second circuit board (preferably, no difference exists in the circuitry on the first and second boards) where it is treated by the magnetic means on the circuit board.

In the embodiment shown, the remotely generated signal is received by the electrodes 113 and 116 of the circuit board. The incoming signal is first processed by common mode choke 120 and then processed across an isolator 122 before being presented to electrodes 133, 137, and 136 for processing by the host system.

Similarly, the signal generated by the host system is received by electrodes 131, 132, and 134, and is processed across a common mode choke 124, and then across an isolator 126. The signal is then processed by a second common mode choke 128. The final magnet processing is a balancing center tap auto-transformer 140 (used primarily to achieve the greatest degree of balance possible) before the signal exits to the remote network through leads 111 and 112. The treated signal is then received by the third electrodes and redirected to the first plurality of electrodes to a motherboard and the internal electric connections. A similar second path allows signals generated internally to be received by the second plurality of electrodes 117 and 118, then to be conditioned by a second common mode choke 120 and a second isolator 122, then to the third plurality of electrodes 133, 137, and 136, once more to the circuit board, and finally being received by the contact insert.

While the circuitry describes herein is fairly conventional, being defined by various governmental and industry standards, it should be noted that the circuitry could be quite different. For various different applications a connector could be made with quite different circuitry still be within the scope of this invention.

This intention has been described with reference to specific examples and embodiments thereof. Variations, alternatives, and modifications will occur to those skilled in the art. The appended claims are intended to encompass all such variations, alternatives and embodiments.

While the circuitry describes herein is fairly conventional, being defined by various governmental and industry standards, it should be noted that the circuitry could be quite different. For various different applications a connector could be made with quite different circuitry still be within the scope of this invention.

This intention has been described with reference to specific examples and embodiments thereof. Variations, alternatives, and modifications will occur to those skilled in the art. The appended claims are intended to encompass all such variations, alternatives and embodiments.

1. A connector, comprising:
a housing having module receiving bays;
at least one module removably mounted in at least one module receiving bay, the module having;
a first end of a first external lead receiver located in at least one first jack connector lead forming a connection for an external electronic source of electronic signal disposed at a first level in the module, located in a jack portion of the module;
a first end of a second external lead receiver located in at least one second jack connector lead for connecting with an external source of electronic signal disposed at a second level in the module above the first level, the at least one first jack connector leads being disposed in a second level in the module, disposed in the jack portion of the module;
a second end of the first external lead receiver leading to and connected with at least one first circuit board having circuitry, the circuit board disposed in a circuit board portion of the module,
a second end of the second external lead receiver leading to and connected with at least one second circuit board having circuitry, the first circuit board and the second circuit board being disposed in a circuit board portion of the module; and
electrical shielding disposed at least partially between the jack portion of the module and the circuit board portion of the module;
a first plurality of spring contacts in the housing removably connecting with a first plurality of connecting conductive leads extending from the first plurality of circuit boards and a second plurality of spring contacts, said second spring contacts in the housing removably connecting with said second plurality of spring contacts in the housing extending connecting with a second plurality of circuit boards; and
motherboard connective pins extending downwardly from the spring contacts.

2. The connector of claim 1 wherein the connector contains between two and eight of the modules.

3. The connector of claim 1 wherein the at least one first jack connective lead is separated from the at least one second jack connective lead by a boundary member.

4. The connector of claim 3 wherein the at least one jack connective lead is proximate the boundary member and the at least one second jack connective lead disposed proximate to the boundary member.

5. The connector of claim 1 wherein the electrical shielding comprises a metallic, non-magnetic member.

6. The connector of claim 5 wherein the housing further comprises means for grounding the electrical shielding.

7. The connector of claim 5 wherein the electrical shielding separates the jack portion of the module and the circuit board portion of the module extending no further than the top of the spring contacts.

8. The connector of claim 1 wherein the housing further comprises means for grounding the electrical shielding.

9. The connector of claim 1, further comprising a top member having a top, a back, a first side, and a second side thereby defining a central hollowed portion separated by the electrical shielding into a jack receiving volume and a circuit board volume.

10. The connector of claim 1 wherein the second jack connective leads extend outwardly from the front of the electrical shielding, following a path parallel to the plane of the back of the electrical shielding, to the top of the electrical shielding, where the at least one of the second jack connective leads follows a path parallel to the plane of the top of the module.

11. The connector of claim 10 wherein the at least one first jack connective lead extends outwardly and runs parallel to the plane of the top of the module.

12. The connector of claim 11 wherein the at least one first circuit board connects with at least one first electric lead and the second circuit board connects with at least one second electric lead.

13. A connector, comprising:
a housing having module receiving bays;
at least one module mounted in at least one module receiving bay, the module having;
a first end of a first external lead receiver located in at least one first jack connector lead forming a connection for an external electronic source of electronic signal disposed at a first level in the module, located in a jack portion of the module;
a first end of a second external lead receiver located in at least one second jack connector lead for connecting with an external source of electronic signal disposed at a second level in the module above the first level, the at least one first jack connector leads being disposed in a second level in the module, disposed in the jack portion of the module;
a second end of the first external lead receiver leading to and connected with at least one first circuit board having circuitry, the circuit board disposed in a circuit board portion of the module,
a second end of the second external lead receiver leading to and connected with at least one second circuit board having circuitry, the first circuit board and the second circuit board being disposed in a circuit board portion of the module; and
electrical shielding disposed at least partially between the jack portion of the module and the circuit board portion of the module;
a first plurality of spring contacts in the housing connecting with a first plurality of connecting conductive leads extending from the first plurality of circuit boards and a second plurality of spring contacts, said second plurality of spring contacts in the housing extending connecting with a second plurality of circuit boards; and
motherboard connective pins extending downwardly from the spring contacts.

14. The connector of claim 13 wherein the connector contains at least one module removably connected to the housing.

15. The connector of claim 13 wherein the connector contains between two and eight of the modules.

16. The connector of claim 13 wherein the at least one first jack connective lead is separated from the at least one second jack connective lead by a boundary member.

17. The connector of claim 17 wherein the at least one jack connective lead is proximate the boundary member and the at least one second jack connective lead is proximate the boundary member.

18. The connector of claim 13 wherein the electrical shielding comprises a metallic, non-magnetic member.

19. The connector of claim 18 wherein the housing further comprises means for grounding the electrical shielding.

20. The connector of claim 18 wherein the electrical shielding separates the jack portion of the module and the circuit board portion of the module extending no further than the top of the spring contacts.

21. The connector of claim 13 wherein the housing further comprises means for grounding the electrical shielding.

22. The connector of claim 13 further comprising a top member having a top, a back, a first side, and a second side thereby defining a central hollowed portion separated by the electrical shielding into a jack receiving volume and a circuit board volume.

23. The connector of claim 13 wherein the second jack connective leads extend outwardly from the front of the electrical shielding, running parallel to the plane of the back of the electrical shielding, to the top of the electrical shielding, and the at least one second lead continues and runs parallel to the plane of the top of the module.

24. The connector of claim 23 wherein the at least one first jack connective lead extends outwardly, running parallel to the plane of the top of the module.

25. The connector of claim 24 wherein the at least one first circuit board attaches with at least one first electric and the second circuit board attaches with at least one second electric lead.

26. A connector module, comprising:
a first level external lead receivers and a second level of external lead receivers within a module housing, the first level of external lead receivers disposed below the second level of external lead receivers;
the first level of external lead receivers and the module housing forming a jack opening to a first circuit board for processing an electric signal;
the second level of external lead receivers and the module housing forming a second jack opening to a second circuit board for processing an electric signal; and
an electrical shield member interposed between the first level external lead receivers and second level external lead receivers.

27. The modular connector of claim 26 wherein the module further comprises a jack opening portion and a circuit board portion separated by electrical shielding.

28. The modular connector of claim 26 wherein a second plurality of leads extends outwardly from the front of the electrical shield, runs through the apertures defined in electrical shielding, continues parallel to the plane of the back of the electrical shield to the top of the electrical shield, and then running parallel to the plane of a top surface of the module housing.

29. The modular connector of claim 26 wherein a first plurality of leads extends outwardly from the plurality of apertures defined on the top surface of the module housing and runs parallel to the second plurality of leads.

30. The modular connector of claim 26 wherein electrical shielding comprises a metal block disposed between a jack opening portion and a circuit board portion.

31. The modular connector of claim 30 further comprising a plurality of circuit boards with a first end and a second end, the first end defining a plurality of apertures to receive the plurality of leads;
a first circuit board attached to the free end of a first plurality of leads; and
a second circuit board attached to the free end of a second plurality of leads.

32. The modular connector of claim 26 wherein at least one of the first and second circuit boards includes means for magnetically conditioning the electric signal.
